(19) United States
(12) Patent Application Publication
(10) Pub. No.: US 2006/0285729 A1
(43) Pub. Date: Dec. 21, 2006

(54) FINGERPRINT RECOGNITION SYSTEM AND METHOD

(76) Inventors: Taek Soo Kim, Gyeongi-do (KR); Hyo Sup Kang, Seoul (KR); Ho Won Kim, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(21) Appl. No.: 11/424,477

(22) Filed: Jun. 15, 2006

(30) Foreign Application Priority Data
Jun. 15, 2005 (KR) 10-2005-0051366
Jun. 23, 2005 (KR) 10-2005-0054313
Jun. 23, 2005 (KR) 10-2005-0054426

(51) Int. Cl. G06K 9/00; G06K 9/36

(52) U.S. Cl. 382/124; 382/284

(57) ABSTRACT

A fingerprint recognition method and system for recognizing a fingerprint by storing local fingerprint images inputted from a fingerprint sensor and compositing the stored local fingerprint images into an effective single fingerprint image. The method includes obtaining relative sliding speed and directional information between the local fingerprint images, correcting sliding speed and directional values of the local fingerprint images using the obtained sliding speed and directional information, and compositing the local fingerprint images into the effective single fingerprint image using the corrected sliding speed and directional values.

### CROSS-REFERENCE TO RELATED APPLICATIONS

Pursuant to 35 U.S.C. § 119(a), this application claims the benefit of earlier filing date and right of priority to Korean Application Nos. 10-2005-0051366, filed Jun. 15, 2005, 10-2005-0054313, filed Jun. 23, 2005, and 10-2005-0054426, filed Jun. 23, 2005, the contents of which are hereby incorporated by reference herein in their entirety

### BACKGROUND OF THE INVENTION

1. Field of the Invention

The present invention relates to a fingerprint recognition system and method.

2. Description of the Related Art

Generally, in security technology, bio-information such as iris or fingerprint information is used to identify a user who can approach a specific machine or enter into a specific building or room. That is, a variety of identification methods based on bio-information recognition such as iris recognition, fingerprint recognition, and the like, have been developed. The identification system using bio-information recognition is used instead of a conventional password method or ID-card to perform personal identification or protect information.

A system using fingerprint recognition includes components for detecting fingerprint information, extracting a fingerprint characteristic from the detected fingerprint information, and performing an identification process by comparing the extracted fingerprint characteristics with pre-registered fingerprint information.

Fingerprint recognition systems have been widely applied to mobile communication devices such as a personal digital assistant (PDA) or a mobile phone since they can be realized by a relative simple structure and has relatively high reliability.

A fingerprint recognition sensor is often used for obtaining fingerprint information. The fingerprint recognition sensor is classified as either an optical type sensor, a thermal detection type sensor, or a semiconductor type sensor. The semiconductor type sensor is further classified into an area type and a slide type. However, since the area type sensor takes up a relatively large space of the mobile communication device, the slide type taking up a relatively small space is generally applied to the mobile communication device.

The slide type sensor performs fingerprint recognition by reading local fingerprint images of a finger sliding thereon and compositing a single fingerprint image from the local fingerprint images.

Conventional methods for compositing the single fingerprint image from the local fingerprint images employ a sequential composition method that updates a current composited fingerprint image by overlapping local fingerprint images inputted from the fingerprint sensor with the current composited fingerprint and matching a relative brightness value of the overlapped area.

A sequential composition method can composite an accurate fingerprint image if a sampling speed of the slide type sensor is sufficiently faster than the sliding speed of a finger, brightness values of one-to-one corresponding pixels in an actual overlapping fingerprint area are identical to each other since gain control of the sensor is optimal, and a geometrical distortion of the fingerprint contacting the sensor during the sliding of the finger is within a negligible range.

However, sliding action relative to the slide sensor can be variably realized according to the user's sliding habit. For example, when the finger slides on the fingerprint sensor, the sliding speed is not uniform, but instead is variable. In addition, the sliding speed at the end of the sliding process is generally faster than the sliding speed at the beginning of the sliding process.

In the extreme, sliding speed may be somewhat faster than the sampling speed of the sensor. In this case, since there is no overlapped portion between the newly inputted fingerprint image and the already composited fingerprint image, brightness value matching is not usually possible. In addition, matching may be falsely realized since there is no practical way to determine the overlapped area. This is represented as a discontinuous fingerprint ridge flow in the composited fingerprint image, thereby deteriorating the recognition rate.

Therefore, in order to solve the above described problem, most fingerprint composition methods determine if the matching result will be registered by comparing a critical value specified to the fingerprint sensor and the matching error value. Nevertheless, the matching may be erroneously performed based upon pressure of the finger on the fingerprint sensor and properties of the finger (for example, a wet finger and a dry finger).

As a result, a sequential fingerprint composition method has a problem in performing image composition when the sampling speed is sufficiently faster than the sliding speed. However, when the sampling speed is identical or similar to the sliding speed, since the composition seems to be realized even when there is no overlapped area, the composition image may be regarded as the effective fingerprint image.

However, when a slide type sensor having a low sampling speed is used, a case where the sampling speed becomes identical or similar to the sliding speed frequently occurs. Therefore, if the case where the sampling speed becomes identical or similar to the sliding speed can be detected, the composition of the local fingerprint images in the slide type sensor having the low sampling speed will be improved.

In addition, the matching of the brightness value in conventional fingerprint recognition systems may be falsely performed. A possibility of the false matching is generally detected using a critical value specified for the fingerprint recognition sensor. However, when the possibility of the false matching is detected, the sliding speed of a sliding operation is simply estimated using a statistic value. This statistic estimating method cannot easily correct erroneous composition of the local fingerprint images when the sliding speed varies at a point of time the false matching is generated.

Meanwhile, in a slide type fingerprint recognition method, since the local fingerprint images are first obtained and the local fingerprint images are composited into a single fingerprint image, the recognition performance and result depends on a finger sliding action of a user on the fingerprint recognition sensor. Particularly, when there is a skewed sliding during the sliding operation, it becomes difficult to composite the local fingerprint images into the single fingerprint image.

Also, since the fingerprint recognition system applied to the mobile communication device has a limited computing source, size of an image inputted for the fingerprint recognition is limited to a predetermined size, and the operation of the system is optimized to the limited size. Therefore, when the skewed sliding is generated, it is difficult to estimate a degree to which the skewed sliding is generated and thus it is difficult to estimate usable memory capacity. As a result, it is difficult to effectively use the memory.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. Accordingly, an embodiment of the present invention is directed to a fingerprint recognition system and method that substantially obviate one or more problems due to limitations and disadvantages of the related art.

An aspect of the present invention is to provide a fingerprint recognition system and method employing local fingerprint image composition which can accurately perform the fingerprint recognition even when finger sliding speed is not uniform.

Another aspect of the present invention is to provide a fingerprint recognition system and method employing local fingerprint image composition which can accurately perform fingerprint recognition even when skewed sliding is generated.

Still another object of the present invention is to provide a fingerprint recognition system and method employing local fingerprint image composition which can accurately perform the fingerprint recognition even when there is a difference between finger sliding speed and a sampling speed of a sensor.

To achieve these objects and other advantages and in accordance with a purpose of the invention, as embodied and broadly described herein, there is provided a fingerprint recognition system including: a fingerprint sensor for sequentially detecting local fingerprint images; a storing unit for storing the detected local fingerprint images; a sliding information extracting unit for extracting relative speed and directional information between the stored local fingerprint images; a correction unit for correcting sliding speed and directional values of the local fingerprint images using the extracted sliding speed and directional information; a composition unit for compositing the local fingerprint images into the effective single fingerprint image using the corrected sliding speed and directional values; and a fingerprint recognition unit for recognizing the effective single fingerprint image.

In another aspect of the present invention, there is provided a fingerprint recognition system for recognizing a fingerprint by storing local fingerprint images inputted from a fingerprint sensor and compositing the stored local fingerprint images into an effective single fingerprint image, the system comprising: means for obtaining relative sliding speed and directional information between the local fingerprint images; means for calculating a coordinate system biasing point for the composition of the local fingerprint images using the obtained sliding speed and directional information; and means for compositing the local fingerprint images into the effective single fingerprint image using the obtained sliding speed and directional information and the calculated coordinated system biasing point.

In still another aspect of the present invention, there is provided a fingerprint recognition method using a system for recognizing a fingerprint by storing local fingerprint images inputted from a fingerprint sensor and compositing the stored local fingerprint images into an effective single fingerprint image, the method including: obtaining relative sliding speed and directional information between the local fingerprint images; correcting sliding speed and directional values of the local fingerprint images using the obtained sliding speed and directional information; and compositing the local fingerprint images into the effective single fingerprint image using the corrected sliding speed and directional values.

In still another aspect of the present invention, there is provided a fingerprint recognition method using a system for recognizing a fingerprint by storing local fingerprint images inputted from a fingerprint sensor and compositing the stored local fingerprint images into an effective single fingerprint image, the method including: obtaining relative sliding speed, direction and fingerprint ridge information between the local fingerprint images; calculating a coordinate system biasing point for the composition of the local fingerprint images using the obtained sliding speed, direction and fingerprint ridge information; and compositing the local fingerprint images into the effective single fingerprint image using the obtained sliding speed and directional information and the calculated coordinated system biasing point.

In still yet another aspect of the present invention, there is provided a fingerprint recognition method using a system for recognizing a fingerprint by storing local fingerprint images inputted from a fingerprint sensor and compositing the stored local fingerprint images into an effective single fingerprint image, the method including: obtaining relative sliding speed and directional information between the local fingerprint images; detecting an overspeed section using the obtained sliding speed and directional information; correcting sliding speed and directional values of the local fingerprint images with respect to the detected overspeed section; and compositing the local fingerprint images into the effective single fingerprint image using the corrected sliding speed and directional values.

In still yet another aspect of the present invention, there is provided a method for detecting a skewed sliding in a fingerprint recognition system, the method comprising: sequentially obtaining local fingerprint images; and detecting relative sliding speed and direction between adjacent local fingerprint images by setting one of adjacent local fingerprint images as a target image and the other as a reference image.

The above-described fingerprint recognition method and system may be applied to a mobile communication device.

According to an embodiment of the present invention, the local fingerprint images inputted by the finger sliding are composited into an effective single fingerprint image. At this point, the local fingerprint images that may be erroneously composited are effectively corrected, thereby effectively solving disadvantages of the conventional sequential composition method without increasing the calculation time and improving the local fingerprint image composition.

Also, since the loss of the fingerprint ridge information, which may be caused by a skewed sliding of the user, can be effectively prevented, the rate of the fingerprint recognition success can be improved.

In addition, by providing the directional information of the skewed sliding to the fingerprint recognition algorithm (fingerprint recognition unit), the fingerprint recognition can be stably performed without increasing the fingerprint recognition time even when there is the skewed sliding. Therefore, the fingerprint recognition system and method of the present invention can scope with a variety of user's sliding habits.

Furthermore, the fingerprint recognition system and method can improve the rate of the fingerprint image composition success even when the finger sliding speed is faster than the sampling speed of the fingerprint recognition sensor that has a low sampling speed.

Also, even when the fingerprint recognition system and method are applied to a mobile communication device having a limited computing resource and the finger sliding speed is not uniform, the fingerprint recognition is accurately realized by minimizing the erroneous composition of the local fingerprint images inputted from the slide type sensor.

These and other embodiments will also become readily apparent to those skilled in the art from the following detailed description of the embodiments having reference to the attached figures, the invention not being limited to any particular embodiment disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments. In the drawings:

FIG. 1 is a view of a mobile communication device employing a slide type fingerprint recognition sensor;

FIG. 2 is a view of an example of local fingerprint images captured by a slide type fingerprint recognition sensor;

FIG. 3 is a block diagram of a fingerprint recognition system according to an embodiment of the present invention;

FIG. 4 is a view of an example of local fingerprint images captured by a fingerprint recognition system according to an embodiment of the present invention;

FIG. 5 is a flowchart of a fingerprint recognition method according to an embodiment of the present invention;

FIG. 6 is a view of an example of a fingerprint image obtained by sliding in a direction of a longitudinal axis;

FIG. 7 is a view of an example of a fingerprint image obtained by sliding the finger at an angle which is skewed relative to a longitudinal axis;

FIG. 8 is a view of an example of biasing of the composition fingerprint image when there is a skewed sliding;

FIG. 9 is a block diagram of a fingerprint recognition system according to another embodiment of the present invention;

FIG. 10 is a flowchart of a fingerprint recognition method according to another embodiment of the present invention;

FIG. 11 is a view of an example of fingerprint images obtained according to a relative relationship between a sample speed of a slide type fingerprint recognition sensor and a finger sliding speed; and

FIG. 12 is a view illustrating a method for processing composition error caused by the absence of an overlapped area in an overspeed section in which sliding speed is equal to or faster than sampling speed.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or similar parts.

### First Embodiment

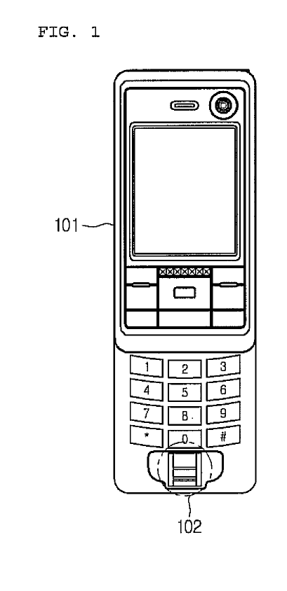

FIG. 1 is a view of a mobile communication device employing a slide type fingerprint recognition sensor.

As shown in FIG. 1, a slide type fingerprint recognition sensor 102 is installed on a mobile communication device 101. When a user's finger slides on the sensor 102, the sensor 102 captures local fingerprint images that have continuity.

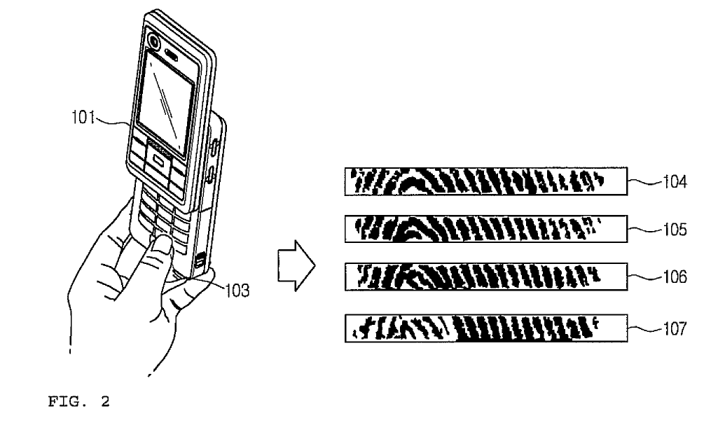

FIG. 2 is a view of an example of the local fingerprint images captured by a slide type fingerprint recognition sensor.

When the user's finger, for example, a thumb 103 slides on the sensor 102, continuous local fingerprints 104 through 107 are captured. As shown in FIG. 2, the user's fingerprint is continuously sliced into a plurality of local fingerprint images. An effective single fingerprint image may be composed from the local fingerprint images and compared with a pre-registered fingerprint image in a fingerprint database to determine, for example, that the person has rights to access mobile device 101.

A fingerprint recognition system according to this embodiment may be used for accurately compositing and recognizing the effective single fingerprint image based upon the individual local fingerprint images. This may be accomplished using a consecutive composition method, regardless of sliding speed variation.

When the user's finger slides on the sensor, relative sliding speed between adjacent local fingerprint images is first calculated. Sliding speed information of an overspeed section or a falsely matching section may be corrected using statistic properties. Then, the local fingerprint images are composited into the effective single image from a finally obtained composition start point using the corrected sliding speed information.

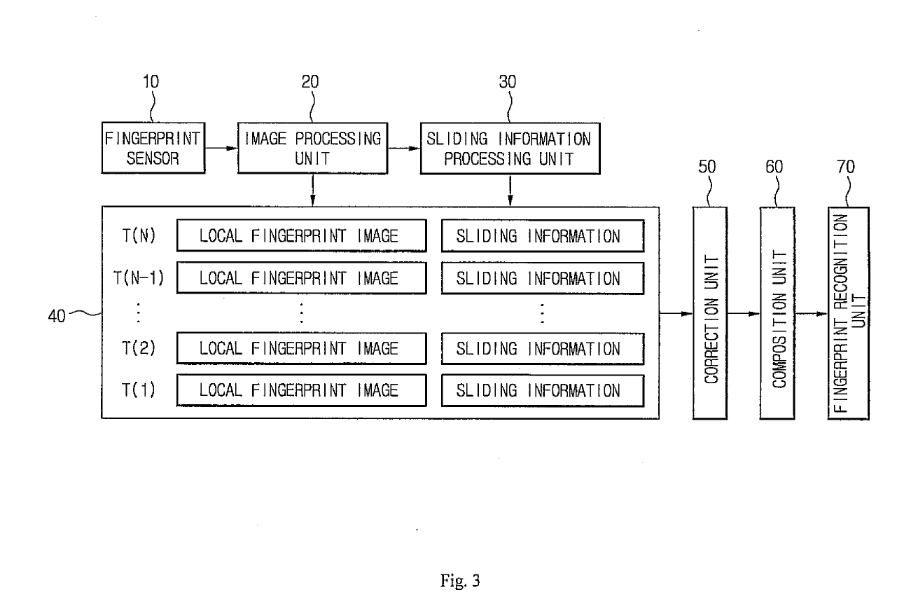

FIG. 3 is a view of a fingerprint recognition system according to an embodiment of the present invention. The fingerprint recognition system depicted in FIG. 3 can be implemented in a mobile communication device, for example.

The fingerprint recognition system according to this embodiment includes a fingerprint sensor 10 for capturing a fingerprint image, an image processing unit 20 for processing local fingerprint images captured by the fingerprint sensor 10, a sliding information processing unit 30 for extracting relative sliding information between local fingerprint images processed by the image processing unit 20. The system further include memory unit 40 for storing the local fingerprint images and sliding information, a correction unit 50 for correcting the local fingerprint images for fingerprint composition using the local fingerprint images and sliding information stored in the memory unit 40, a composition unit 60 for the composition of the corrected local fingerprint images into an effective single fingerprint image, and optional fingerprint recognition unit 70 for performing, if desired, fingerprint image recognition using the effective single fingerprint image.

The fingerprint sensor 10 may be implemented using a slide type semiconductor sensor that can scan the user's fingerprint to form a series of local fingerprint images when the user's finger slides on a recognition window thereof.

The local fingerprint images captured by the fingerprint sensor 10 are inputted to the image processing unit 20. The image processing unit 20 performs a sampling drive of the fingerprint sensor 10 and converts the captured local fingerprint images into a digital signal to provide fingerprint recognition based upon the pixels. Before searching for sliding speed and direction, the image processing unit controls brightness values of reference and target images so that mean brightness values of these elements can be identical to each other. This will be described in more detail later.

The sliding information extracting unit 30 extracts sliding information, which may include the sliding speed and direction of each of the local fingerprint images. That is, the sliding information extracting unit extracts relative speed and directional information between adjacent local fingerprint images. The memory unit 40 stores the local fingerprint images that are sequentially inputted and the sliding information of each local fingerprint image.

The correction unit 50 corrects the relative sliding information between the local fingerprint images stored in the memory unit 40 to prevent erroneous composition caused by the non-uniform sliding speed or a difference between the sliding speed and the sampling speed of the fingerprint sensor.

The composition unit 60 composites the corrected local fingerprint images into the effective single fingerprint image. The fingerprint recognition unit 70 performs the recognition/identification process with respect to the user's fingerprint using the effective single fingerprint image.

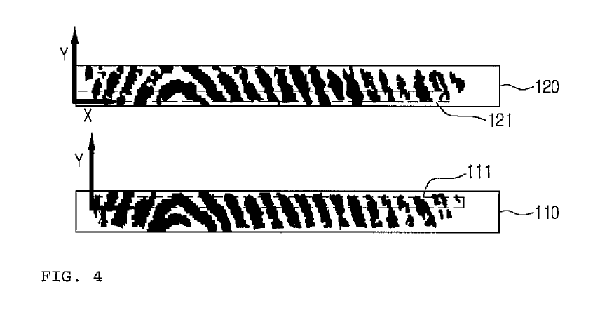

FIG. 4 is a view of an example of the local fingerprint images captured by the fingerprint recognition system according to an embodiment of the present invention.

There are shown first and second local fingerprint images 110 and 120 that are continuous and adjacent to each other. The first local fingerprint image 110 is a current local fingerprint image that is being inputted from the fingerprint sensor 10 and the second local fingerprint image 120 is a former local fingerprint image that is already inputted from the fingerprint sensor 10. The current and former local fingerprint images may be defined by one of the following two cases.

First, the case in which correction and composition are performed in real time, the local fingerprint image that is being currently inputted is the current local fingerprint image and a local fingerprint image that has already been inputted is the former local fingerprint image.

Second, in the case in which correction and composition are performed after all of the local fingerprint images have been inputted, a selected one of the local fingerprint images is the current local fingerprint image and a local fingerprint image and a former local fingerprint image is one which is inputted just prior to the selected local fingerprint image.

The composition and recognition methods based on the relative sliding information correction of the local fingerprint images may be identically applied to any one of the above two cases.

When the first local fingerprint image 110 is a reference image, the second local fingerprint image 120 becomes a target image. On the other hand, when the second local fingerprint image 120 is a reference image, the first local fingerprint image 110 becomes a target image. In order to extract and correct the relative sliding information between the local fingerprint images, a portion of an area of the second target image 120 is set as a target or search slice 121, and a portion of an area of the reference image 110 is set as a reference slice 111. A detailed method using the slices 111 and 121 will be described later.

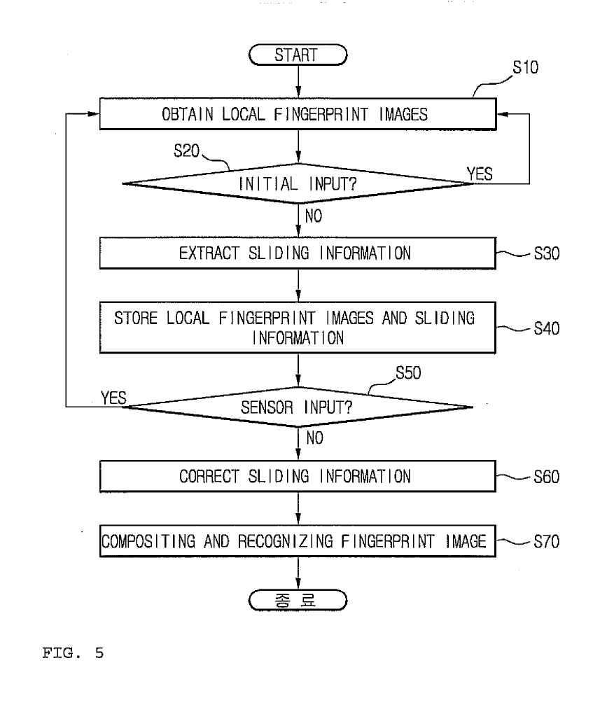

FIG. 5 is a flowchart of a fingerprint recognition method according to an embodiment of the present invention.

The local fingerprint images are first obtained (S10). It is determined if a local fingerprint image that is being currently inputted is an inputted image that is firstly inputted (S20). When a local fingerprint image that is being currently inputted is a local fingerprint image that is inputted after at least more than one local fingerprint image is inputted, relative sliding information between the current local fingerprint image and the former local fingerprint image is extracted (S30). Then, the obtained local fingerprint images and the sliding information are stored in the memory unit (S40). It is then determined if there is any additional input from the fingerprint sensor (S50). When there is no addition input from the fingerprint sensor, the sliding information between the local fingerprint images is corrected (S60). After this operation, the local fingerprint images are composited into an effective single fingerprint image using the corrected sliding information (S70).

The above-described fingerprint recognition method will be now described in more detail.

The fingerprint recognition system may begin operation by receiving input when finger sliding action starts and it is detected that an initial local fingerprint image is inputted. The local fingerprint images inputted from the fingerprint sensor 10 may be stored in the memory unit 40. Sliding information is usually extracted only after the second local fingerprint image is inputted.

When the required two or more local fingerprint images have been inputted, the sliding information is extracted. That is, a current local fingerprint image T(N) and a former local fingerprint image T(N−1) that is inputted just prior to the current local fingerprint image T(N) is inputted are read. These parameters may be used to calculate the relative sliding speed and directional information between adjacent (i.e., current and former) local fingerprint images. The relative sliding direction and speed may be extracted by comparing brightness values of overlapped portions of the current and former local fingerprint images.

That is, one of the current and former local fingerprint images is set as the reference image and the other is set as the target image. Then, a local point at which a difference between the brightness values of overlapped pixels between the reference and target images is smallest is searched. In the current example, the reference and target images are consecutive local fingerprint images inputted from the fingerprint sensor 10 and the sizes thereof are substantially identical. In order to effectively search for the local point, a specific area of the target image is set as the search slice and a specific area of the reference image is set as the reference slice.

For example, as shown in FIG. 4, a specific area of the first local fingerprint image 110 is set as the reference slice and a specific area of the second local fingerprint image 120 is set as the search slice. In this example, a brightness value of each pixel overlapped with the reference slice 111 is calculated while moving the second local fingerprint image 120 in directions of longitudinal and lateral axes X and Y of the fingerprint sensor 10 and the local point where the brightness value difference is smallest is searched.

Similarly, when the local fingerprint images stored in the memory unit 40 are examined, the images T(N−1) and T(N) are first read and the local point is searched while moving the image T(N) in the directions of the longitudinal and lateral axes X and Y of the fingerprint sensor 10. That is, when the target image overlaps with the reference image, the local point where the brightness value difference between corresponding pixels of the reference and target slices is searched.

Next, when the brightness value difference of the overlapped areas is smallest, a degree of a relative pixel biasing between a reference slice coordinate and a target slide coordinate is used to calculate the sliding speed and direction. That is, a degree of the relative biasing of the target image in the directions of the longitudinal and lateral axes X and Y with reference to the reference slice image when the bright difference of the overlapped areas is smallest is calculated by a pixel unit. Therefore, the relative speed and direction of the adjacent local fingerprint images can be calculated.

As described above, the adjacent local fingerprint images may have a common overlapped area, or may not have the common overlapped area when the finger sliding speed is faster than the sampling speed of the fingerprint sensor.

In addition, the location and size of the reference slice image 111 may be varied or fixed. The location and size of the reference image 110 are fixed during the calculation of the sliding direction and speed. When a new local fingerprint image is inputted from the fingerprint sensor 10 according to the sliding speed and directional information between the former local fingerprint images, the location and size of the reference image 110 is variably adjusted. This is to more effectively extract the sliding information and search a local point having the smallest brightness value difference between corresponding pixels. In addition, before the sliding speed and directional information is extracted, the brightness value is adjusted by applying an identical gain to the reference and target images so that the mean brightness values of the reference and target images can be identical to each other, thereby improving the image search efficiency and accuracy.

Next, the calculated sliding speed and directional information and the brightness value difference information are synchronized with the inputted local fingerprint images and stored in the memory unit 40.

A series of the above-described processes are repeated until the final local fingerprint image is inputted. As a result, all of the local fingerprint images T(1), T(2), . . . , T(N−1), T(n), and the relative sliding speed and directional information between the adjacent local fingerprint images are extracted and stored in the memory unit 40.

When the finger sliding action is ended, it is inspected by the correction unit 50 if the composition of the local fingerprint images is accurately realized using the sliding information stored in the memory unit 40.

According to an aspect of the present invention, image composition is not realized right after calculation of the relative sliding direction and speed between adjacent local fingerprint images are calculated. That is, after the relative sliding direction and speed of all adjacent local fingerprint images has been calculated, the relative sliding directions and speeds which were erroneously composited is corrected, after which all of the adjacent local fingerprint images are composited using the corrected sliding direction and speed information. Here, the relative sliding direction and speed between all adjacent local fingerprint images is a relative sliding direction and speed calculated from the combination of the local fingerprint images that are sequentially generated from a point of time the finger sliding action is started to a point of time the finger sliding action is finished.

When the relative sliding speed of adjacent local fingerprint images has a discontinuity out of the allowable error range, it is determined that a composition error is generated. It is then determined if a smallest brightness value error occurring when the composition error is generated is within a range allowed by the fingerprint sensor 10. When the smallest brightness value error is out of the range, the sliding information of the subject slice is corrected using the surrounding sliding speed information.

That is, a statistic value on the sliding speed and the continuity of the sliding direction of each local fingerprint image combinations obtained from the overall sliding is applied to detect if there is a composition error. Namely, when the sliding speed and direction of adjacent local fingerprint images are discontinuous, it is determined that there is a composition error. When the brightness value error occurring when there is the composition error is out of the allowable range, the sliding speed information of the subject local fingerprint image is corrected using the sliding speed information of another local fingerprint image around the subject local fingerprint.

When the composition error is corrected, the image composition unit 60 composites the local fingerprint images stored in the memory unit 40 into the effective single fingerprint image using the corrected sliding speed and directional information. At this point, an area that will be overlapped a following local fingerprint image is not composited, thereby reducing the processing time.

When the composition is completed, the composited image is transmitted to the fingerprint recognition unit 70. The fingerprint recognition unit 70 extracts characteristic information of the effective single fingerprint image and identifies the user using the extracted characteristic information.

### Embodiment 2

A fingerprint recognition system according to this embodiment may be used for accurately compositing and recognizing the effective single fingerprint image from local fingerprint images using a consecutive composition method, regardless of the sliding skew.

According to this embodiment, when there is a sliding skew by the user's sliding habit, the subject local fingerprint image moves to an optimal coordinate according to the sliding speed and directional information between the local fingerprint images. Therefore, the fingerprint recognition can be accurately performed by the composition of the local fingerprint images in the above state where the subject local fingerprint image is moved to the optical coordinate.

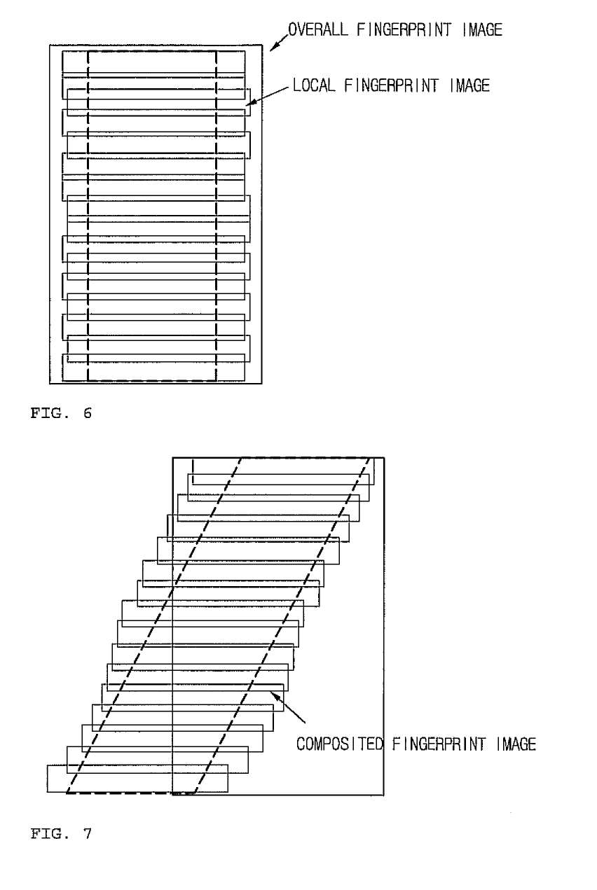

FIG. 6 is a view of an example of a fingerprint image obtained by the finger sliding in a direction of a longitudinal axis and FIG. 7 is a view of an example of a fingerprint image obtained by the skewed sliding of the finger in a direction of a longitudinal axis.

In the consecutive composition method using the slide type sensor, as shown in FIGS. 6 and 7, when there is sliding in the lateral direction as well as the longitudinal direction, it is difficult to optimize the fingerprint information inputted from the fingerprint sensor. That is, when there is skewed sliding, since the next sliding direction cannot easily be estimated, the finally composited fingerprint image may be greater in size than the overall fingerprint image as shown in FIG. 7. In this case, the fingerprint ridge information of a portion out of the overall fingerprint image size cannot be represented in the effective signal fingerprint image.

Therefore, as shown in FIG. 7, in order to maximize the information capacity of the skewed sliding image, the composited fingerprint image must move according to the information capacity of the fingerprint ridge having region of interest (ROI) pixels of the composited fingerprint image and the location information of the ROI pixels. Embodiments of the present invention provide a method and system that can improve the recognition rate by maximizing the fingerprint ridge information capacity by calculating an optimal biasing amount of the composited fingerprint image and moving the composited fingerprint image to an optimal location.

In addition, when there is a skewed sliding, the optimal biasing point of the composited image will be set after identifying the finally composited image. Therefore, it becomes possible to estimate and identify the degree of the skew and memory capacity that will be used for the consecutive composition, the memory efficiency will be improved. Furthermore, the time spent calculating the biasing information of the finally composited image to a new memory space will be minimized.

Particularly, since the calculation time and the memory capacity that will be used can be reduced, the fingerprint recognition can be improved in the mobile communication device having limited computing resources. In addition, the image composition error that may be caused by skewed sliding on the slide type sensor can be prevented.

Accordingly, in an embodiment of the present invention, the relative sliding speed and direction between the adjacent local fingerprint images are first calculated. The ROI pixels for calculating the fingerprint ridge information capacity is searched on the local fingerprint images and an including degree of the fingerprint ridge is extracted and inspected. The optimal coordinate biasing point is calculated using the relative sliding speed and direction and the fingerprint ridge information.

Finally, the calculated biasing point is applied to the sliding speed and direction to composite the local fingerprint images into the effective single fingerprint image with reference to an image coordinate system. Therefore, when there is a skewed sliding, the optimal composition image can be realized using less calculation time and memory capacity as compared with the conventional consecutive composition methods.

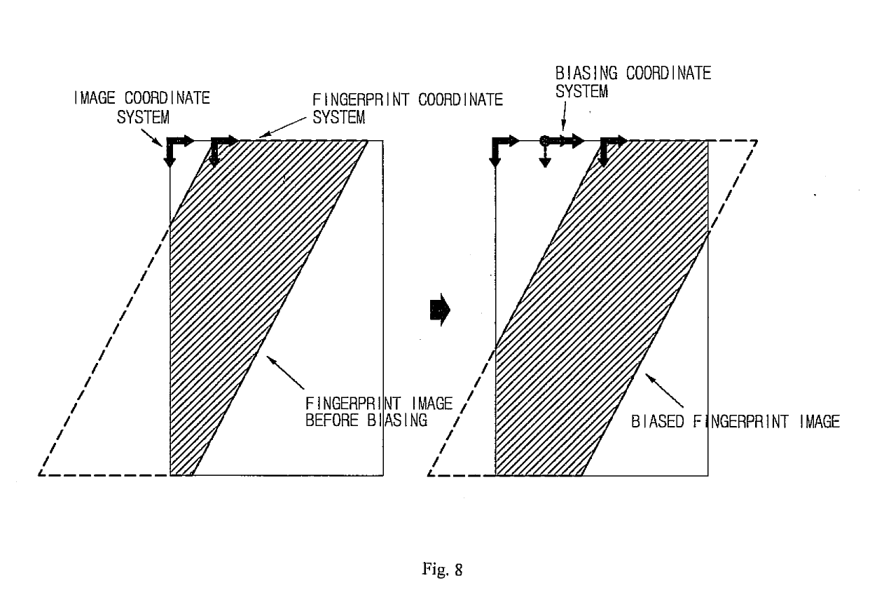

FIG. 8 is a view of an example of biasing of the composition fingerprint image when there is skewed sliding. Referring to FIG. 8, it can be noted that there is severe skewed sliding in a former fingerprint image and the ridge information capacity that can be obtained from the subject local fingerprint image is damaged. However, by moving the subject local fingerprint image according to the fingerprint ridge information capacity, such as the sliding speed and direction search information capacity and the ROI information capacity of the local fingerprint images, the fingerprint ridge information capacity is maximized to be sufficient to perform the fingerprint recognition as shown in the image moved.

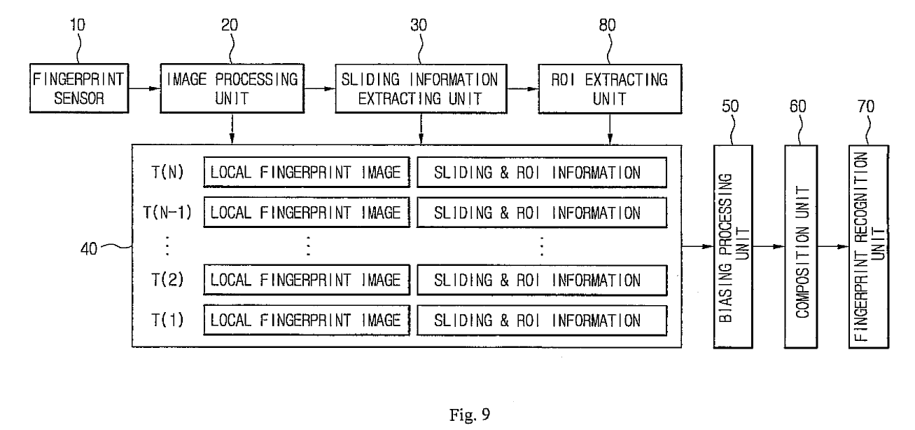

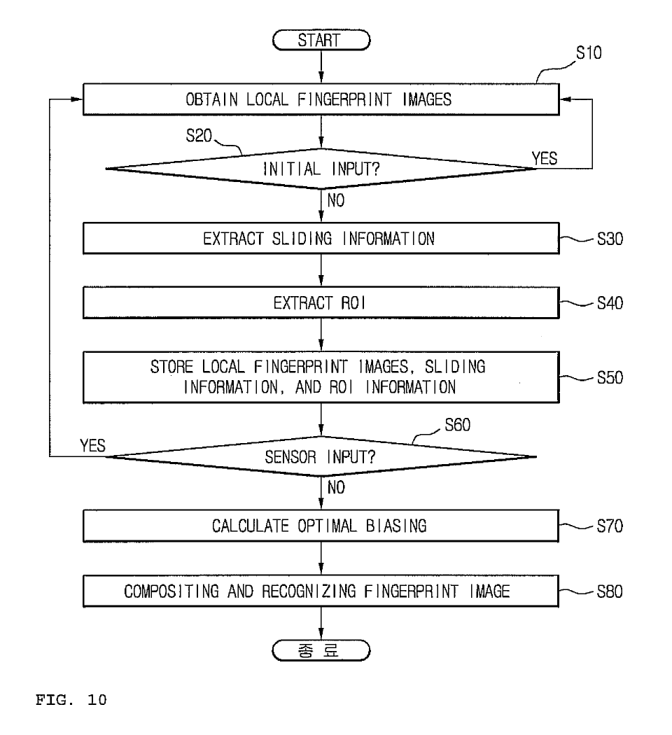

FIG. 9 shows a fingerprint recognition system according to this embodiment.

The fingerprint recognition system according to this embodiment includes a fingerprint sensor 10 for capturing a fingerprint image, an image processing unit 20 for processing local fingerprint images captured by the fingerprint sensor 10, a sliding information extracting unit 30 for extracting relative sliding information between the local fingerprint images processed by the image processing unit 20, an ROI extracting unit 80 for extracting the fingerprint ridge information capacity from the local fingerprint image, a memory unit 40 for storing the local fingerprint images, the sliding information and the ROI information, a biasing processing unit 50 for calculating a degree of an optimal biasing for a fingerprint composition using the local fingerprint images, sliding information, and ROI information stored in the memory unit 40, a composition unit 60 for composition of the corrected local fingerprint images into an effective single fingerprint image, and a fingerprint recognition unit 70 for performing a fingerprint image recognition using the effective single fingerprint image.

The fingerprint sensor 10 and image processing unit 20 operate in a manner similar to that described in conjunction with FIG. 2.

The sliding information extracting unit 30 extracts sliding information including the sliding speed and direction of the local fingerprint images. That is, the sliding information extracting unit extracts relative speed and directional information between the adjacent local fingerprint images.

The ROI extracting unit 80 calculates ROI pixels having a fingerprint ridge in the inputted local fingerprint image. That is, the local fingerprint image is divided into blocks, each having a predetermined size and determines whether the ROI registration will be done after identifying the fingerprint distribution at each block.

The memory unit 40 stores the local fingerprint images that are sequentially inputted, the sliding information of each local fingerprint image, and the ROI information.

The biasing processing unit 50 calculates, when the user's sliding action is finished, the fingerprint ridge information capacity using the relative sliding information between the local fingerprint images and ROI information stored in the memory unit 40 to obtain an optimal degree of biasing information without performing an actual image composition process.

The composition unit 60 composites the corrected local fingerprint images into the effective single fingerprint image. The fingerprint recognition unit 70 performs the recognition/identification process with respect to the user's fingerprint using the effective single fingerprint image.

FIG. 10 is a flowchart of a fingerprint recognition method according to this embodiment.

The local fingerprint images are first obtained (S10). It is determined if a local fingerprint image that is being currently inputted is an inputted image that is firstly inputted (S20). When a local fingerprint image that is being currently inputted is a local fingerprint image that is inputted after at least more than one local fingerprint image is inputted, relative sliding information between the current local fingerprint image and the former local fingerprint image is extracted (S30). ROI information for calculating the fingerprint ridge information capacity from the local fingerprint image is extracted (840). Then, the local fingerprint images, the sliding information and the ROI information are stored in the memory unit (S50). It is determined if there is any input from the fingerprint sensor (S60). When there is no additional input from the fingerprint sensor, the optimal biasing point between the local fingerprint images is calculated (S70). The local fingerprint images are composited into an effective single fingerprint image using the information skew-corrected according to the optimal biasing point.

The above-described fingerprint recognition method will be now described in more detail with reference to the accompanying drawings.

The fingerprint recognition system begins operation when a finger sliding action starts and it is detected that an initial local fingerprint image is inputted. The local fingerprint images inputted from the fingerprint sensor 10 are stored in the memory unit 40. When the initial local fingerprint image is inputted, the sliding information cannot be extracted. Thereby, the extraction of the sliding information is performed after a next local fingerprint image is inputted.

When two or more local fingerprint images are inputted, the sliding information is extracted. That is, a current local fingerprint image T(N) and a former local fingerprint image T(N−1) that is inputted just before the current local fingerprint image T(N) is inputted are read and the relative sliding direction and speed information between the current and former local fingerprint images is extracted. The sliding direction and speed are extracted by comparing brightness values of overlapped portions between the current and former local fingerprint images (as described above in conjunction with FIG. 5).

Next, the ROI extracting unit 80 divides the inputted local fingerprint image into blocks each having a predetermined size and determines whether the ROI registration will be done after identifying the fingerprint distribution at each block. That is, the ROI pixels having the fingerprint ridge of the inputted local fingerprint image are calculated. Next, the calculated sliding speed and directional information, the brightness value difference information, and the ROI registration information are synchronized with the inputted local fingerprint images and stored in the memory unit 40.

A series of the above-described processes are repeated until the final local fingerprint image is inputted. As a result, all of the local fingerprint images T(1), T(2), . . . , T(N) and the relative sliding speed and directional information between the adjacent local fingerprint images are extracted and the ROI registration information for calculating the fingerprint information capacity is stored in the memory unit 40.

The biasing processing unit 50 calculates, when the user's sliding action is finished, the fingerprint ridge information capacity using the relative sliding information between the local fingerprint images and ROI information stored in the memory unit 40 without performing an actual image composition process. That is, before the actual image composition process is performed, the ROI location information and the fingerprint ridge information capacity of the imaginary composition image are calculated. Here, the fingerprint ridge information capacity of the overall fingerprint image that is to be composited can be obtained by estimating the fingerprint ridge information capacity of the ROI pixels contained in the each local fingerprint image using the relative speed and directional information of the each local fingerprint image. When the estimation is applied to all of the local fingerprint images and accumulated, the fingerprint ridge information capacity of the overall fingerprint image can be calculated without performing the actual composition process.

A local point of an overlapped area between the composition image and the overall fingerprint image that will be composited, which has a maximum information capacity, is searched according to the ROI location information and fingerprint ridge information capacity of the imaginary fingerprint image that will be composited while biasing the overlapped image. The optimal biasing information (optimal biasing point) as in FIG. 8 is obtained by calculating a degree of a relative biasing between the local point having the maximum information capacity and the reference location of the subject composition image. That is, the local point having the maximum information capacity is searched according to the location information of the ROI pixels and the fingerprint ridge information capacity of the imaginary fingerprint image and the optimal biasing information (optimal biasing point) of the overall fingerprint image that will be composited is obtained by calculating a degree of relative biasing between the local point having the maximum information capacity and the reference location of the subject composition image.

In the present invention, the composition is not realized right after the relative sliding direction and speed information between the adjacent local fingerprint images is calculated. That is, after the sliding direction and speed information of all of the adjacent local fingerprint images is calculated, the sliding direction and speed information that is erroneously composited is corrected, after which all of the adjacent local fingerprint images are composited using the corrected sliding direction and speed information. Here, the sliding direction and speed information between all of the adjacent local fingerprint images is a relative sliding direction and speed calculated from the combination of the local fingerprint images that are sequentially generated from a point of time the finger sliding action is started to a point of time the finger sliding action is finished.

When skewed sliding is corrected, the image composition unit 60 composites the local fingerprint images stored in the memory unit 40 into the effective single fingerprint image using the corrected sliding speed and directional information. At this point, an area that will be overlapped a following local fingerprint image is not composited, thereby reducing the processing time.

When the composition is completed, the composited image, the sliding information and the ROI information of the composition image are transmitted to the fingerprint recognition unit 70. The fingerprint recognition unit 70 extracts characteristic information of the effective single fingerprint image and identifies the user using the extracted characteristic information.

### Embodiment 3

A fingerprint recognition system according to this embodiment may be used for accurately compositing and recognizing the effective single fingerprint image from local fingerprint images using a consecutive composition method regardless of the sliding speed variation. Particularly, an embodiment provides for accurately performing the composition with respect to an overspeed section in which sliding speed is faster than the sampling speed of the fingerprint sensor.

When the user's finger slides on the sensor, relative sliding speed between adjacent local fingerprint images is first calculated, and sliding speed information of an overspeed section or a false matching section is corrected using statistic properties. Then, the local fingerprint images are composited into the effective single image from a finally obtained composition start point using the corrected sliding speed information.

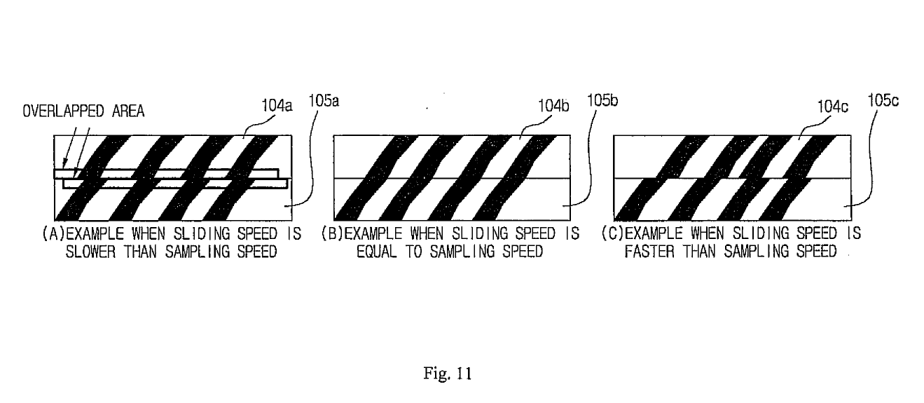

FIG. 11 is a view of an example of fingerprint images obtained according to a relative relationship between a sample speed of a slide type fingerprint recognition sensor and a finger sliding speed.

In FIG. 11, image A shows adjacent local fingerprint images 104a and 105a when the sampling speed is faster than the sliding speed. Image B shows adjacent local fingerprint images 104b and 105b when the sampling speed is equal to the sliding speed, and image C shows adjacent local fingerprint images 104c and 105c when the sampling speed is slower than the sliding speed.

As shown in FIG. 11, when the sliding speed is equal to or faster than the sampling speed, there is no overlapped area between the newly inputted local fingerprint image 104b (104c) and the formerly inputted fingerprint image 105b (105c). In this case, it becomes difficult to perform the brightness value matching process and the discontinuity fingerprint ridge flow is generated in the composited fingerprint image, thereby deteriorating the recognition rate.

However, in accordance with an embodiment of the present invention, the overspeed section is detected and corrected to solve the composition error problem generated in the overspeed section where the sliding speed is equal to or faster than the sampling speed.

The fingerprint recognition method according to this embodiment can be applied to the fingerprint recognition system depicted in FIG. 3 or FIG. 9. The methods for calculating the relative sliding speed and direction described above applies equally to this embodiment.

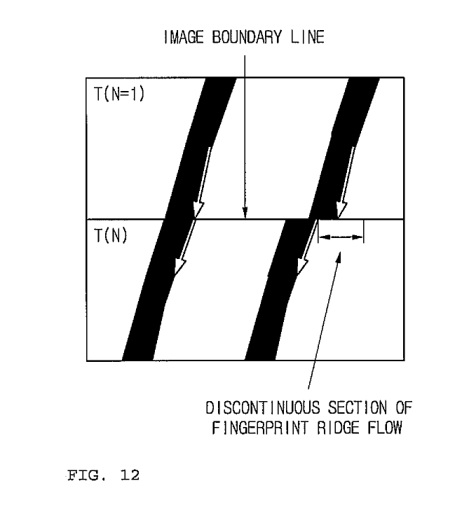

FIG. 12 is a view illustrating a method for processing a composition error caused by the absence of the overlapped area in the overspeed section where the sliding speed is equal to or faster than the sampling speed.

It is assumed that fingerprint images T(N) and T(N−1) are continuous images and a continuity inspection of the fingerprint ridge flow is inspected at a boundary line between the fingerprint images. When the discontinuity section of the fingerprint ridge flow is within an allowable range, it is determined that the sliding speed is equal to the sampling speed and the sampling speed is registered as a sliding speed of the subject local fingerprint image.

A fingerprint recognition method will be now described.

The fingerprint recognition system begins operation when a finger sliding action starts and it is detected that an initial local fingerprint image is inputted. The local fingerprint images inputted from the fingerprint sensor 10 are stored in the memory unit 40. When the local fingerprint image inputted is an initial local fingerprint image, the sliding information cannot be extracted. Thereby, the extraction of the sliding information is performed after a next local fingerprint image is inputted.

When two or more local fingerprint images are inputted, the sliding information is extracted. That is, a current local fingerprint image T(N) and a former local fingerprint image T(N−1) that is inputted just before the current local fingerprint image T(N) is inputted are read and the relative sliding direction and speed information between the current and former local fingerprint images is extracted. The sliding direction and speed are extracted by comparing brightness values of overlapped portions between the current and former local fingerprint images.

As described above, the adjacent local fingerprint images may have a common overlapped area or may not have the common overlapped area when the finger sliding speed is faster than the sampling speed of the fingerprint sensor. Next, the calculated sliding speed, directional information, and brightness value difference information are synchronized with the inputted local fingerprint images and stored in the memory unit 40. A series of the above-described processes are repeated until the final local fingerprint image is inputted. As a result, all of the local fingerprint images T(1), T(2), . . . , (T(N−1), and T(N) and the relative sliding speed and directional information between the adjacent local fingerprint images are extracted and stored in the memory unit 40.

When the finger sliding action is finished, it is inspected by the correction unit 50. If there is a composition error due to the absence of the overlapped area between the local fingerprint images, the sliding information is stored in the memory unit 40.

In the present invention, the composition need not be realized right after the relative sliding direction and speed information between the adjacent local fingerprint images is calculated. That is, after the sliding direction and speed information of all of the adjacent local fingerprint images is calculated, the sliding direction and speed information that is erroneously composited is corrected, after which all of the adjacent local fingerprint images are composited using the corrected sliding direction and speed information. Here, the sliding direction and speed information between all of the adjacent local fingerprint images is a relative sliding direction and speed calculated from the combination of the local fingerprint images that are sequentially generated from a point of time the finger sliding action is started to a point of time the finger sliding action is finished.

When the relative sliding speed of the adjacent local fingerprint images is out of the allowable range and the sliding speed of the adjacent local fingerprint images approximates to the sampling speed of the sensor, it is determined that a composition error is generated due to the absence of the overlapped region.

That is, a relative sliding speed difference of the adjacent local fingerprint images is calculated according to the above-described method and compares the sliding speed difference with a predetermined allowable reference value of the fingerprint sensor. When the difference is greater than the predetermined allowable reference value, the sliding speed of adjacent local fingerprint images adjacent to the above local fingerprint images is compared with the sampling speed of the fingerprint sensor to determine if the sliding speed approximates to the sampling speed. When the sliding speed approximates the sampling speed, it is determined that there is a composition error due to the absence of the overlapped area. That is, by using the local fingerprint images and the sliding speed information of the local fingerprint images and comparing the sliding speed with the sampling speed, it is determined if there is the composition error due to the absence of the overlapped area.

When the sliding speed of the adjacent fingerprint images approximates the sampling speed and the composition brightness value difference of the adjacent fingerprint images gradually increases to over the allowable value, it is determined that there is the composition error due to the absence of the overlapped area. That is, the calculated sliding speed of the adjacent fingerprint images is compared with the sampling speed approximates to the sampling speed to determine if the sliding speed approximates the sampling speed. When the sliding speed approximates the sampling speed and the composition brightness value difference of the adjacent fingerprint images gradually increases to over the allowable value, it is determined that there is the composition error due to the absence of the overlapped area.

At the same time, the local fingerprint images where the composition error is generated due to the absence of the overlapped area is processed to correct the sliding information on the overspeed section according to the following process.

The local fingerprint image where the composition error is generated due to the absence of the overlapped area is first selected. It is regarded that the selected local fingerprint image and another local fingerprint image are a continuous image as shown in FIG. 12. The continuity of the fingerprint ridge flow of the fingerprint images regarded as the continuous image is inspected.

The discontinuous section of the fingerprint ridge flow, which is formed at a boundary line of the fingerprint images, is detected and compared with a predetermined allowable range. When the discontinuous section of the fingerprint ridge flow is within the predetermined allowable range, it is determined that the sliding speed is identical to the sampling speed of the fingerprint sensor and the sampling speed is registered as the sliding speed of the subject local fingerprint image (the sliding speed stored in the memory is corrected). In this case, although there is no actual overlapped area between the local fingerprint images, since the local fingerprint images are inputted as if they are composited into the effective single fingerprint image, the subject local fingerprint image is determined as the effective sliding.

When the composition error is corrected, the image composition unit 60 composites the local fingerprint images stored in the memory unit 40 into the effective single fingerprint image using the corrected sliding speed and directional information. At this point, an area that will be overlapped a following local fingerprint image is not composited, thereby reducing the processing time.

When the composition is completed, the composited image is transmitted to the fingerprint recognition unit 70. The fingerprint recognition unit 70 extracts characteristic information of the effective single fingerprint image and identifies the user using the extracted characteristic information.

The foregoing embodiments and advantages are merely exemplary and are not to be construed as limiting the present invention. The present teaching can be readily applied to other types of apparatuses and processes. The description of the present invention is intended to be illustrative, and not to limit the scope of the claims. Many alternatives, modifications, and variations will be apparent to those skilled in the art.

1. A fingerprint recognition method using a system for recognizing a fingerprint by storing local fingerprint images inputted from a fingerprint sensor and compositing the stored local fingerprint images into an effective single fingerprint image, the method comprising:
obtaining relative sliding speed and directional information between the local fingerprint images;
correcting sliding speed and directional values of the local fingerprint images using the obtained sliding speed and directional information; and
compositing the local fingerprint images into the effective single fingerprint image using the corrected sliding speed and directional values.

2-42. (canceled)
